(19) United States
(12) Patent Application Publication
(10) Pub. No.: US 2011/0072976 A1
(43) Pub. Date: Mar. 31, 2011

(54) METHOD OF REDUCING THE QUANTITY OF LEAD RELEASED BY BRONZE AND/OR BRASS WATER-SYSTEM COMPONENTS INTO LIQUIDS THAT ARE INTENDED FOR HUMAN CONSUMPTION

(76) Inventors: Claudio VOLONTE', Saronno VA (IT); Stefano Carrera, Omegna VB (IT)

(21) Appl. No.: 12/874,686

(22) Filed: Sep. 2, 2010

(30) Foreign Application Priority Data
Sep. 25, 2009 (EP) 09425373.9

(51) Int. Cl. A47J 31/54; C23C 28/02; B32B 15/01

(52) U.S. Cl. 99/279; 205/184; 428/646; 392/441

(57) ABSTRACT

A method of reducing the quantity of lead released by water-system components made of metal alloys containing lead when they are in contact with liquids intended for making beverages for human use comprises at least the following steps in sequence:
preliminary reduction of the quantity of lead contained in the material constituting the components,
coating of the components thus treated, at least on the surface which is to come into contact with the liquids, by the chemical deposition of a tin layer,
coating of the water-system components, at least on their surface that was treated by the deposition of the tin layer, by the electrolytic deposition of a covering metal alloy.

The present invention relates to a method of reducing the quantity of elements harmful to human health, particularly lead, that are released by water-system components made of metal alloys such as bronze and brass when they come into contact with liquids intended for making beverages for human consumption.

Water-system components means tubes, connectors, taps, valves and boilers which are normally used in plumbing systems and in the construction of machines for preparing beverages for human use such as, for example, coffee-making and dispensing machines which also include the dispensing of both hot and cold milk and the preparation of infusions such as, for example, tea and camomile tea.

Liquids that are processed in these machines and are intended for human use have to satisfy stringent standards which impose certain limits on the permitted quantities of materials that are harmful to human health, amongst which are lead and nickel.

As is known, the above-mentioned water-system components are normally made of bronze or brass which are alloys of copper and tin and of copper and zinc, respectively.

Percentages of lead are also known to be present in these alloys since lead is added to the copper alloy to make the material more easily workable.

The addition of lead to copper-and-zinc and copper-and-tin alloys leads to the risk that, during the use of the water systems of which they form parts, components made of the alloys may release lead into the liquids, even though in minimal and very variable quantities, and the lead may then be ingested by the consumption of beverages made with the liquids.

Since the above-mentioned element is considered very harmful to human health, over time, ever stricter and more stringent standards have been set with a view to greatly limiting its presence in beverages.

In Europe, the standard referred to is CE No. 1935/2004.

In the United States of America, on the other hand, it is the standard NSF (NATIONAL SANITATION FOUNDATION) 4, which imposes very low limits for lead concentration (no more than 15 μg/l) which are difficult to achieve except by procedures for cleansing water-system components; these procedures are economically penalizing, particularly when considered in relation to the nature of the water-system components and their use.

According to a known technique, in order to limit the problems resulting from the migration of lead from the water-system components to the liquids which pass through them, it has been proposed to reduce the quantity of free lead that is present in the copper alloy of which the components are made.

Examples of this technique, which may be defined as deleading, are described in EP-A 1,134,306 and in U.S. Pat. No. 5,958,257. According to this prior art, the water-system components are subjected to washing in a bath containing a carboxylic acid.

In practice, however, it has been found that, although simply washing the components considerably reduces the quantity of lead that is transferred to the fluids inside the water-system components from the copper-based alloy of which they are made, it is not sufficient to prevent the migration of the residual free lead.

For example, since, as is known, physical and chemical phenomena are affected by temperature, a water-system component which is subjected to deleading treatment as described in U.S. Pat. No. 5,958,257 or, for example, in EP 1,134,306, may give a transfer below the permissible maximum limit if it is used at the normal temperatures for a municipal water-pipe, whereas this limit may be exceeded if the same component is used in apparatus characterized by significantly higher operating temperatures such as, for example, those present in a coffee-making machine.

It has been found that the deleading operation by washing in a bath containing carboxylic acid leads to microporosity in the surface of the component which still favours a significant migration of the further residual free lead from the innermost layers of the material towards the liquids passing through the component.

A marked reduction in lead transfer can be achieved by the deposition of a layer of nickel by an electrolytic process or by a chemical process.

A tin coating also produces an effective protection against lead transfer. However, because of the nature of tin, a coating of this type is characterized by unsatisfactory durability.

As far as nickel coating is concerned, although, on the one hand, it reduces lead transfer in a satisfactory manner, on the other hand, it introduces the problem of exceeding the permissible limits for nickel transfer.

To prevent this transfer being exceeded, a particular alloy has been developed which comprises, amongst other things, nickel and tin, and which has a surface strength still approximating to that of nickel but at the same time limits nickel transfer by virtue of the presence of the tin.

However, this alloy has a limitation since it can be deposited solely electrochemically and hence with poor penetration into the internal ducts of some components. It cannot therefore be used effectively alone to constitute the coating of the components though they have already been subjected to deleading operations.

Another known technique is to coat the bronze or brass water-system components with a composition containing bismuth nitrate which is applied by immersion in a bath that contains it, in the expectation that the coating can prevent the migration of lead atoms through the coated surface by which the components come into contact with the liquid.

An example of this technique is described in U.S. Pat. No. 5,544,859.

In practice, however, this technique does not ensure impermeability to the migration of lead, or possibly of nickel, over time since the coating will wear in time, long before the end of the average useful life of the components.

The object of the present invention is to solve the problem of the migration of lead from water-system components such as tubes, taps, connectors and boilers made of copper-based alloys into the liquids which pass through them so as effectively to satisfy the requirements both of the European health standards (Regulation CE No. 1935/2004) and of those of the United States (NSF 4), in a durable and economically advantageous manner.

This object is achieved by the method of appended Claim 1 which is intended to be incorporated herein by reference.

According to the invention, water-system components which are made of brass or bronze and are intended to be subject to flows of liquids for beverages for human use are subjected to a preliminary treatment for reducing the quantity of free lead contained therein.

This treatment may be constituted by a step of washing in a bath containing a carboxylic acid, particularly acrylic acid.

After this step, the components are subjected to a coating with a layer of tin which is preferably deposited chemically without the use of electricity to reach a thickness of between 2 and 4 μm.

The tin layer has been found to lead to substantial sealing of the intrinsic porosity of the material and of the porosity that is created as a result of the preliminary deleading treatment performed in the first step of the method, which has proved useful in spite of the problems discussed above.

The chemical tin deposition step is followed by a surface coating step by means of which the tin layer is covered by the electrolytic deposition of a metal alloy of tin and nickel.

It has been found that, as well as supplementing and reinforcing the protection against lead transfer, the deposition of the covering layer, preferably with a thickness of between 2 and 4 μm, confers adequate resistance on the underlying tin layer, improving its long-term effectiveness.

According to the invention, the metal alloy for covering the tin layer comprises nickel and tin, preferably in proportions of about 35% of nickel and 65% of tin.

Tests carried out on samples of water-system components treated by the method according to the invention and on corresponding samples of components treated by the methods of the prior art have shown that the method according to the invention considerably reduces the migration of lead elements from the water-system components towards the liquids which pass through them, to the extent of reducing that migration substantially to zero, fully satisfying the health standards that are in force, as can be seen from the examples given below.

### EXAMPLE 1

A boiler of the type usable in professional coffee-making machines with a capacity of about 2.9 litres, which was made of components that were welded to brass components, was subjected to a conventional pickling and rinsing step.

It was then filled with 1.7 litres of water to which a small quantity of hydrochloric acid had been added to increase its aggressiveness by reducing its pH to a value of 5.

The boiler thus filled was kept for 24 hours at a relative saturated vapour pressure of 1.2 bar, corresponding to a temperature of 122.6° C., so as to reflect the working conditions expected for this component which, in a coffee machine, is the component which is subjected to the greatest thermal stress.

At the end of the period indicated above, the water contained in the boiler was analyzed by the APAT CNR IRSA Atomic Absorption Spectroscopy method, by means of a graphite furnace.

A lead content of 10.72 μg/l was found.

### EXAMPLE 2

A boiler with copper components welded to brass components as in Example 1 was subjected to a conventional pickling and rinsing step which was followed by a deleading step by immersion in a bath containing acrylic acid. After drying, the boiler was filled and subjected to the same heat treatment as described in Example 1.

At the end of the treatment period, analysis of the water, performed by the same apparatus as in Example 1, detected a lead content of 2.154 μg/l.

### EXAMPLE 3

A boiler with copper components welded to brass components as in Examples 1 and 2 was subjected, after pickling, rinsing and deleading, to an electrolytic coating with an alloy comprising nickel and tin.

After the heat treatment as described in Examples 1 and 2, the water was analyzed by the same apparatus as in Examples 1 and 2, giving as the result the presence of 1.423 μg/l of lead.

### EXAMPLE 4

A boiler with copper components welded to brass components as in the preceding examples, of the type used particularly in espresso coffee machines, was subjected, after the deleading step, to a treatment for the chemical deposition of tin to achieve a layer the thickness of which varied between 2 and 4 μm. An electrochemical deposition of an alloy comprising nickel and tin was performed on the tin layer, forming a layer the thickness of which varied between 2 and 4 μm.

Each deposition step was followed by a step of washing in water and drying.

After filling with water supplemented with hydrochloric acid and heat treatment as indicated in the preceding examples, analysis of the water, performed by the same apparatus as in the preceding examples, detected a quantity of lead no greater than 0.075 μg/g, this value being the limit of detectability of the analysis apparatus used.

### EXAMPLE 5

A boiler made entirely of brass and having the same capacity as the boilers used in the preceding examples was subjected to the same treatments of deleading, chemical deposition of a tin layer, and coating thereof by electrolytic deposition of an alloy layer containing nickel and tin to give layer thicknesses as indicated in Example 4.

Each deposition step was followed by a step of washing in water and drying.

After filling with water supplemented with hydrochloric acid to adjust the pH to a value of 5 and heat treatment as indicated in the preceding examples, analysis of the water, performed with the same apparatus as used in the preceding examples detected a lead quantity no greater than 0.075 μg/l, this being the limit of detectability of the analysis apparatus used.

The results of the tests can be summarized in the following table.

| COMPONENT | lead (μg/l) |
|---|---|
| Boiler Ex. 1 | 10.72 |
| Boiler Ex. 2 | 2.154 |
| Boiler Ex. 3 | 1.423 |
| Boiler Ex. 4 and 5 | <0.075* |

It can be seen from these results that a water-system component such as, for example, a boiler for use in coffee machines, that was made of copper components welded to brass components, as well as a boiler that was made entirely of brass, when treated in accordance with the method according to the invention, led to a transfer of lead to the water with a quantity of less than 0.075 μg/l, amply satisfying the health standards which are currently in force and which limit this quantity to values no greater than 15 μg/l.

1. A method of reducing the quantity of lead released by water-system components made of metal alloys containing lead when they are in contact with liquids intended for making beverages for human use, comprising at least the following steps in sequence:
preliminary reduction of the quantity of lead contained in the material constituting the components,
coating of the components thus treated, at least on the surface which is to come into contact with the liquids, by the deposition of a tin layer,
coating of the water-system components, at least on their surface that was treated by the deposition of the tin layer, by the electrolytic deposition of a covering metal alloy.

2. A method according to claim 1 in which the preliminary reduction of the quantity of lead contained in the material constituting the components comprises the immersion of the components in a bath containing at least a carboxylic acid.

3. A method according to claim 1 in which the deposition of a tin layer is performed chemically.

4. A method according to claim 3 in which the tin layer has a thickness of between 2 and 4 μm.

5. A method according to claim 1 in which the covering metal alloy to be deposited electrolytically on the tin layer is a metal alloy comprising nickel and tin.

6. A method according to claim 5 in which the covering metal alloy comprises 35% of nickel and 65% of tin.

7. A method according to claim 1 in which the covering comprises a covering metal alloy having a thickness of between 2 and 4 μm.

8. A method according to claim 1 characterized in that it includes a step of washing of the water-system components in water upon completion of each deposition step.

9. A method according to claim 1 in which the material constituting the water-system components is bronze.

10. A method according to claim 1 in which the material constituting the water-system components is brass.

11. A method according to claim 1 in which the material constituting the components is copper welded to brass.

12. A water-system component treated according to the method according to claim 1.

13. A boiler for espresso coffee machines which is made of copper components welded to brass components and is treated by the method according to claim 1.
